(19) United States
(12) Patent Application Publication
(10) Pub. No.: US 2014/0034200 A1
(43) Pub. Date: Feb. 6, 2014

(54) TIRE WITH LAMINATE

(71) Applicant: Bridgestone Americas Tire Operations, LLC, Nashville, TN (US)

(72) Inventors: Jon I. STUCKEY, Louisville, OH (US); Kathleen CLEMMER, Akron, OH (US); David JOHNSON, Mount Juliette, TN (US); Jacob Lee WALTERS, Medina, OH (US); Michael A. BERZINS, Brecksville, OH (US); Wilbur Eugene HOLMES, North Augusta, SC (US); Todd Alan BUXTON, Norton, OH (US); Kent David WEATHERWAX, Akron, OH (US); Autumn T. KAHWAJI, Fairlawn, OH (US)

(73) Assignee: Bridgestone Americas Tire Operations, LLC, Nashville, TN (US)

(21) Appl. No.: 13/954,249

(22) Filed: Jul. 30, 2013

Related U.S. Application Data
(63) Continuation-in-part of application No. 13/895,149, filed on May 15, 2013.
(60) Provisional application No. 61/678,075, filed on Jul. 31, 2012.

(51) Int. Cl. B60C 11/00

(52) U.S. Cl. CPC B60C 11/00
USPC 152/167

(57) ABSTRACT

A tire includes a circumferential tread constructed of a base material. The circumferential tread has a plurality of tread elements, with each of the plurality of tread elements having a top surface and a plurality of side surfaces. The circumferential tread further has a plurality of grooves disposed between the plurality of tread elements. A laminate covers at least some of the plurality of tread elements and at least some of the plurality of grooves. The laminate has greater snow traction than the base material.

### CROSS REFERENCE TO RELATED APPLICATIONS

This application is a non-provisional application that claims priority to U.S. Provisional Patent Application No. 61/678,075 filed Jul. 31, 2012, the disclosure of which is incorporated herein by reference in its entirety. This application is a continuation-in-part of U.S. patent application Ser. No. 13/895,149 filed on May 15, 2013, the disclosure of which is incorporated herein by reference in its entirety.

### FIELD OF INVENTION

The present disclosure relates to a tire having a laminate disposed thereon and to methods of its preparation. More particularly, the present disclosure relates to a tire with a laminate having different attributes than the base rubber of the tire tread.

### BACKGROUND

Known tire treads are rubber compositions which contain at least some carbon black reinforcement and are thereby black in color. The rubber of a tread may be selected for its material properties, such as its hardness. As the tread wears, the tread rubber maintains the same material properties.

### SUMMARY OF THE INVENTION

In one embodiment, a tire includes a pair of sidewalls and a circumferential tread constructed of a base rubber. The circumferential tread has a plurality of grooves disposed therein, thereby defining a plurality of tread elements. The tire further includes a polymeric laminate disposed on the circumferential tread. The polymeric laminate covers at least one of the plurality of grooves, and the polymeric laminate covers a top surface of at least one of the plurality of tread elements. The polymeric laminate has greater snow traction than the base rubber.

In another embodiment, a tire includes a circumferential tread constructed of a base material. The circumferential tread has a plurality of tread elements, with each of the plurality of tread elements having a top surface and a plurality of side surfaces. The circumferential tread further has a plurality of grooves disposed between the plurality of tread elements. A laminate covers at least some of the plurality of tread elements and at least some of the plurality of grooves. The laminate has greater snow traction than the base material.

In yet another embodiment, a tire includes a pair of sidewalls and a circumferential tread constructed of a base rubber. The circumferential tread has a plurality of tread elements, with each of the plurality of tread elements having a top surface and a plurality of side surfaces. The circumferential tread further has a plurality of grooves disposed between the plurality of tread elements. A laminate is disposed on the circumferential tread, such that the laminate covers at least a portion of the plurality of side surfaces of the plurality of tread elements. The base rubber has lower snow traction than the laminate.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of one embodiment of a tire having a laminate disposed in grooves of the tread;

FIG. 2 is a perspective view of an alternative embodiment of a tire having a laminate disposed thereon;

FIG. 3 is a cross-section of one embodiment of a tire having a laminate disposed on a circumferential tread;

FIG. 4 is a cross-section of one embodiment of a tire having a laminate disposed in grooves of a circumferential tread;

FIG. 5 is a cross-section of one embodiment of a tire having a laminate disposed on a circumferential tread and a pair of sidewalls; and

FIG. 6 is a cross-section of one embodiment of a tire having a laminate disposed on a pair of sidewalls.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

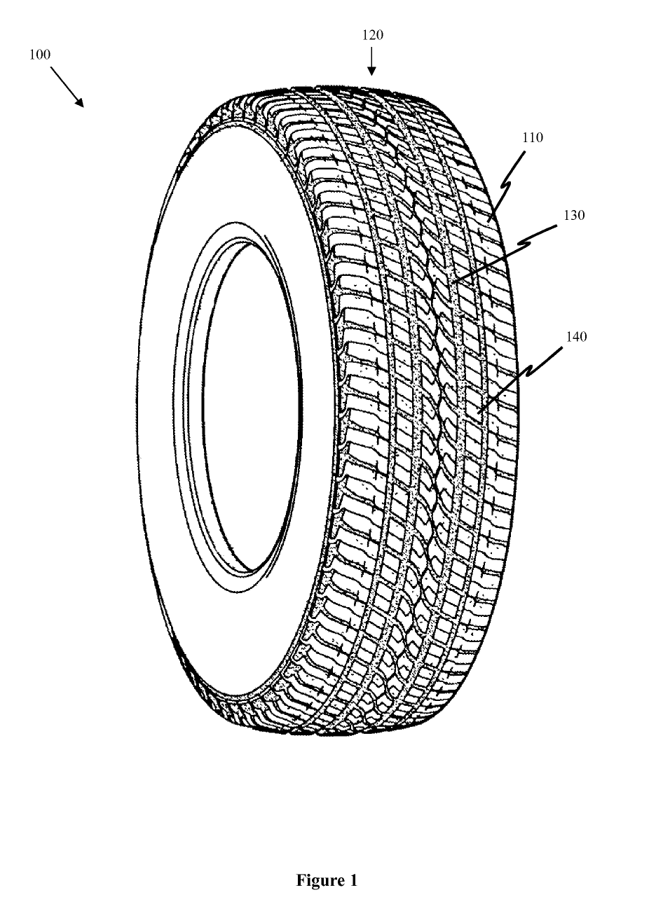

FIGS. 1-6 show various embodiments of tires having a laminate disposed on at least a portion of the external surface of the tire. The laminate may be rubber, or another polymeric material. In one embodiment, the laminate has a thickness of less than 1.5 millimeters. In another embodiment, the laminate has a thickness of 1.0 to 1.5 millimeters. However, it should be understood that thicker laminates may be employed. The thickness of the laminate may be exaggerated in the drawings for illustrative purposes.

FIG. 1 illustrates a perspective view of one embodiment of a tire 100 having a circumferential tread 110 with grooves 120 disposed therein. The tire 100 has a laminate 130 disposed in the grooves 120. In the illustrated embodiment, the circumferential tread 110 includes a plurality of blocks 140. In alternative embodiments (not shown), the tire may include one or more tread elements such as lugs or solid circumferential ribs. It should be understood that the tire is not limited to having any particular tread design.

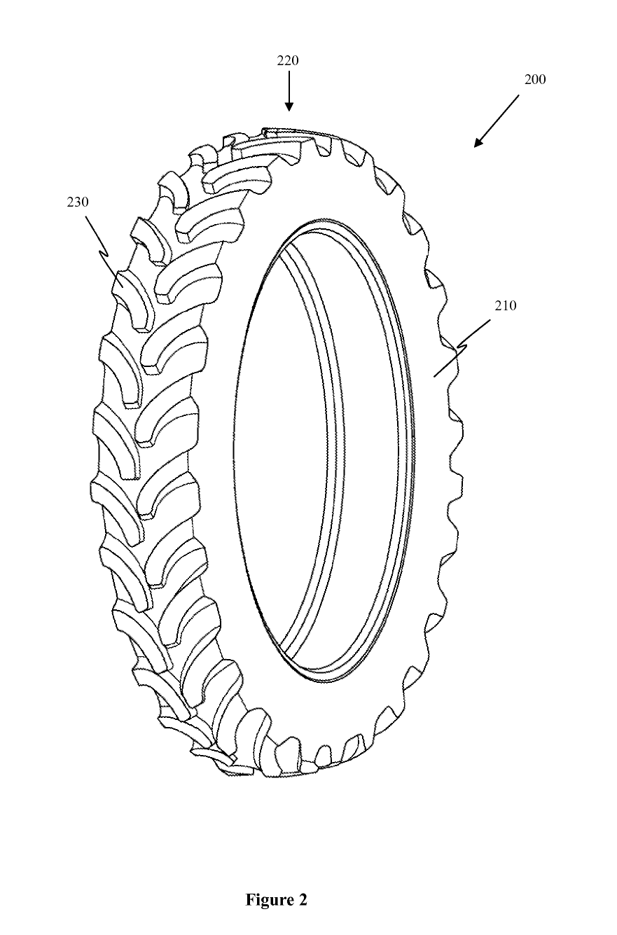

FIG. 2 illustrates a perspective view of an alternative embodiment of a tire 200 having a laminate 210 disposed thereon. In the illustrated embodiment, the laminate 210 covers substantially the entire external surface of the tire. In the illustrated embodiment, tire 200 has a circumferential tread 220 with a plurality of lugs 230. In alternative embodiments (not shown), the tire may include one or more solid circumferential ribs, or one or more blocks. It should be understood that the tire is not limited to having any particular tread design.

While FIG. 1 illustrates a tire 100 suitable for a passenger vehicle and FIG. 2 illustrates a tire 200 suitable for an agricultural vehicle, these tires are merely exemplary. It should be understood that the laminates described herein may be employed on tires for any vehicle, including without limitation, bicycles, motorcycles, all-terrain vehicles, cars, trucks, tractors and other agricultural vehicles, mining vehicles, airplanes, and all other wheeled vehicles. The material properties of the laminate may be varied according to the vehicle type, and the expected use of the tire.

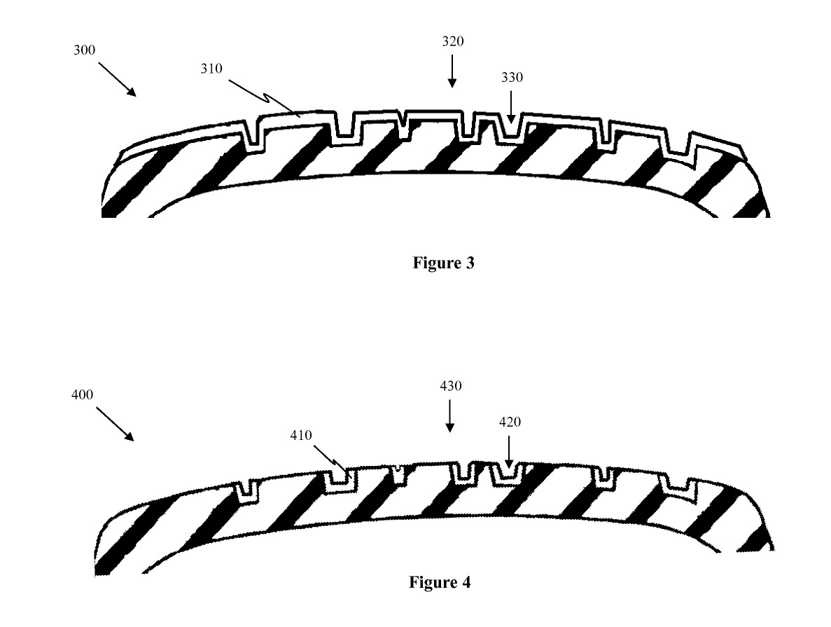

FIG. 3 illustrates a cross-section of one embodiment of a tire 300 having a laminate 310 disposed on a circumferential tread 320. The laminate 310 covers both the top surface of the tread 320 and the grooves 330 disposed in the tread 320. The laminate 310 may also cover slots, sipes, and other tread elements (not shown).

FIG. 4 illustrates a cross-section of one embodiment of a tire 400 having a laminate 410 disposed on the surface of grooves 420 of a circumferential tread 430. The laminate 410 may also cover slots, sipes, and other tread elements (not shown). In the illustrated embodiment, the laminate does not cover the top surface of the circumferential tread 430, i.e. the portion of the circumferential tread that comes into contact with a road or other rolling surface.

In one method of making the tire 400, the laminate 410 is first disposed over the entire circumferential tread 430 such that it covers both the top surface of the tread 430 and the grooves 420 disposed therein. The laminate 410 on the top surface of the tread 430 is then buffed off or ground away, using an abrasive grinding material. In such an embodiment, the laminate may be recycled after it is ground off the tire. Alternatively, the laminate 410 on the top surface of the tread 430 may be worn away during use of the tire 400 on a vehicle.

In an alternative method of making the tire 400, the laminate 410 is only disposed on the surface of the grooves 430 and the top surface of the tread 430 is left uncovered by the laminate 410. In such an embodiment, no grinding or wearing of the laminate 410 is necessary.

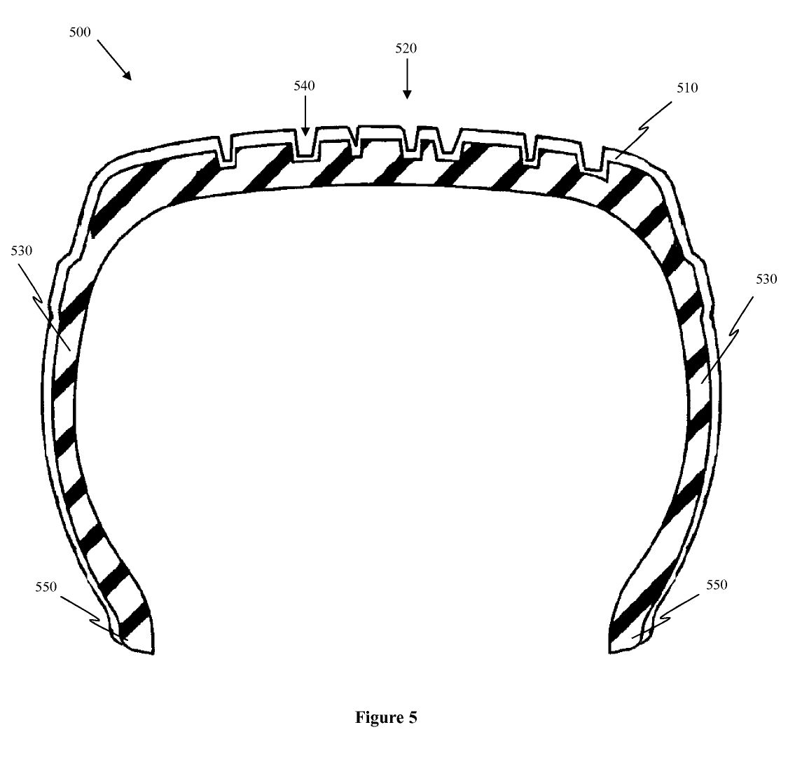

FIG. 5 illustrates a cross-section of one embodiment of a tire 500 having a laminate 510 disposed on a circumferential tread 520 and a pair of sidewalls 530. The laminate 510 covers both the top surface of the tread 520 and the grooves 540 disposed therein. The laminate 510 may also cover slots, sipes, and other tread elements (not shown). In the illustrated embodiment, the laminate 510 extends down each sidewall 530 to the heel 550 of the tire 500. In alternative embodiments (not show), the laminate may only cover a portion of each sidewall. It should be understood that the coverage of each sidewall need not be the same. For example, the laminate may cover an outer sidewall of a tire, but not the inner sidewall of the tire.

While the coverage of the laminate is shown as continuous, it should be understood that gaps may exist. For example, the laminate 510 may be disposed on the surface of grooves 540 of a circumferential tread 520, but not on the top surface of the tread 520 in the same manner shown in FIG. 4. Additionally, portions of the sidewall 530 may be left uncovered or the laminate may be ground away from portions of the sidewall 530.

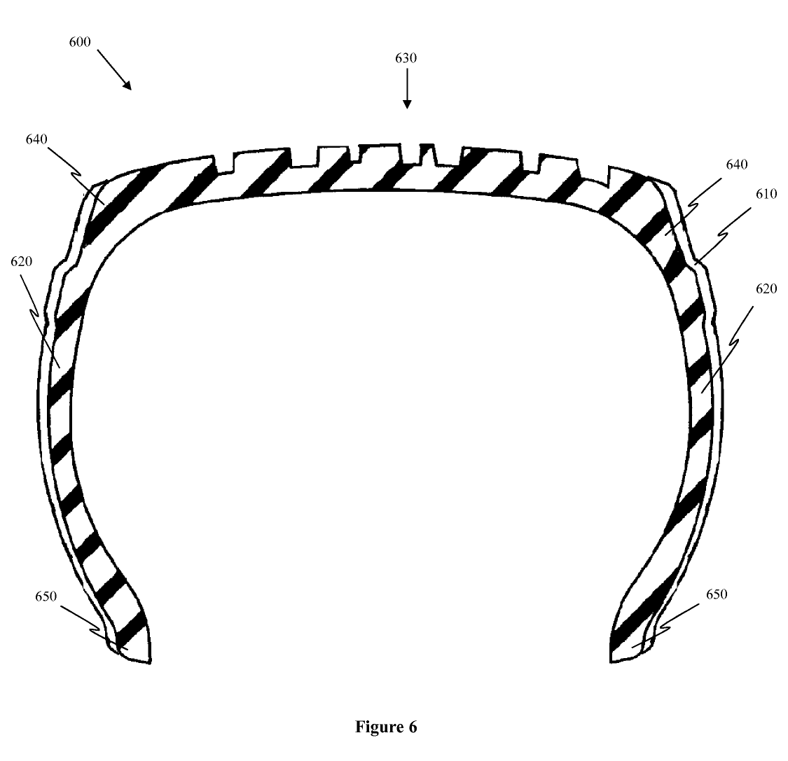

FIG. 6 illustrates a cross-section of one embodiment of a tire 600 having laminates 610 disposed on a pair of sidewalls 620. In the illustrated embodiment, the laminate does not cover the circumferential tread 630 of the tire 600. Instead, the laminate 610 extends from a shoulder portion 640 of each sidewall 620 to the heel 650 of the tire 600. In alternative embodiments (not show), the laminate may only cover a portion of each sidewall. It should be understood that the coverage of each sidewall need not be the same. For example, the laminate may cover an outer sidewall of a tire, but not the inner sidewall of the tire.

In the above-described embodiments, the laminate may be rubber, or another polymeric material. In one particular embodiment, the laminate does not include carbon black. In such an embodiment, the laminate may include pigments of any color or combination of colors. Colors may be employed for aesthetic reasons. For example, laminates may be colored to display a design, text, logos, brand names, or other pictures or photographs. A user may determine that it is aesthetically pleasing to have a color laminate that is disposed only in the grooves, or disposed on both the tread and the grooves. Multiple colors may be employed on a single laminate. For example, the laminate may have colors in a camouflage pattern. In one embodiment, a user may customize the tire by providing an image that is transferred to the laminate.

The color of the laminate may also be used as an indicator. The use of color as an indicator allows the tire to display the same information to an observer, regardless of whether the car is stopped or moving. For example, the color may be selected to indicate material properties of the laminate itself. Or the color may be selected to indicate a property of the tire. In one example, a blue laminate may be employed on a tire that has superior handling in wet conditions. In another example, a green laminate may be employed to indicate that the tire is fuel efficient, or otherwise environmentally friendly.

A color laminate may also function as a wear indicator. When the laminate is a different color than the base rubber, the exposure of the base rubber provides a visual indication of the level of wear of the tire.

Additionally, the color may be used to identify a brand. For example, a tire brand may be associated with a particular color. Additionally, a car brand, car rental service brand, or non-vehicular service or product may be associated with a particular color.

Color may also serve as an indicator in a racing environment. For example, a color may be used to designate a racing team. A color may also be used to identify a points leader in a racing series, or the pole position vehicle. Additionally, a color may be used to indicate that a particular type of tire is being used in a race. In one example, the color may be used to indicate a hardness of a compound used in the tire tread.

The laminate may also be selected for its material properties. In one example, the laminate is constructed of a material that is harder than the base rubber of the tire. Such a laminate may be useful in agricultural tires, and tires for off-road vehicles. As is understood in the art, agricultural tires are susceptible to damage from corn stalks, rocks, and other hard objects. Likewise, tires on off-road vehicles are susceptible to damage from rocks and other hard objects.

When the laminate has a greater hardness than the base rubber, the laminate may have a different color than the base rubber. The use of different colors would provide an indicator that the laminate has worn away from the top surface of a tire tread. Alternatively, the laminate may have the same color than the base rubber to provide a uniform appearance.

In another example, the laminate may have material properties that produce greater snow traction, making the laminate more suitable for snow performance than the base rubber. In one such example, the laminate has a low modulus of elasticity, such that the laminate is softer than the base rubber. Such a laminate may perform better in cold weather, which hardens the rubber.

The laminate may also include sipes or cuts to provide additional traction in snow. In one embodiment, the sipes may extend through the entire laminate without extending into the base rubber. In an alternative embodiment, the sipes may only extend partially through the laminate. In another alternative embodiment, the sipes may extend through the entire laminate and extend through part of the base rubber.

In the above-described embodiments, the base rubber of the tire may be suited for all seasons. Accordingly, such a tire would have superior winter characteristics initially, for its first season of use, when the top surface of the tread is covered by the laminate (such as shown in FIG. 3). When the tire is used, and the laminate wears off the top surface of the tread (such as shown in FIG. 4) then the base rubber is exposed, and the tire has all season performance thereafter. The thickness of such a laminate could be selected for various wear rates, so that the laminate lasts through the winter and is worn away by the spring.

When the laminate has material properties more suitable for snow performance than the base rubber, the laminate may have a different color than the base rubber. The use of different colors would provide an indicator that the laminate has worn away from the top surface of a tire tread. Alternatively, the laminate may have the same color than the base rubber to provide a uniform appearance.

In another example, the laminate is made of an ozone resistant material. Such a material would resist cracking in sunlight, and may be particularly useful in the grooves of a tread.

In still another example, the laminate is a sealant. Such an embodiment may be particularly useful for tires on mining vehicles. In yet another example, the laminate may have air permeability different from the base rubber.

In one embodiment, the use of a laminate on the tread of a tire enhances performance as the tire wears. For example, where a laminate is disposed on the top surface of the tread and in the grooves (such as shown in FIG. 3), the laminate on the top surface of the tread wears away during use of the tire, resulting in a tire having laminate only in the grooves of the tire (such as shown in FIG. 4). In one known embodiment, the laminate in the grooves is a soft material that improves snow performance.

Although FIGS. 1-6 display the use of a single laminate, it should be understood that more than one laminate may be employed. In one embodiment, different laminates are employed in different sections of the tire. For example, different laminates may be used on a sidewall, top surface of a tread, and grooves of a tread. Where multiple laminates are disposed on different portion of the tire, different colored laminates may be employed to form a desired pattern. For example, different laminates may be used to form a camouflage pattern on the tire.

In an alternative embodiment, one or more laminates may be layered on top of one another. Where layers of laminates are disposed on the top surface of a tread, each layer is worn away during use of the tire. As the first layer is worn, the second layer becomes exposed. In such a configuration, each laminate in the layer may have a different color. An observer will then be able to visually detect as layers are worn away and other layers are exposed.

Additionally, where multiple layers of laminates are employed, each layer may have a different material property. For example, an outer layer may be constructed of a material that exhibits superior snow performance, an inner layer may be constructed of a material that exhibits superior wet performance, and the remaining compound of the tire may be constructed of a material that exhibits superior dry performance. Such a tire may be suitable for geographic locations that have a snowy winter, followed by a wet spring, and a dry summer. The thickness of each layer may be selected based on the various wear rates for each weather condition.

In another example, a first layer may be an ozone resistant material and a second layer may be a softer material for cold weather and snow performance. During the curing of the tire, the ozone resistant material may leach from the first layer into the second layer.

The laminate may be applied to the tire in a number of different ways. In one embodiment, the laminate is disposed on the tire by co-extruding the laminate with the rubber of the tire.

In an alternative embodiment, the laminate is disposed on the tire by forming a thin sheet of material and separately building a green tire. The laminate may then be placed on a desired location of the green tire, and the green tire and laminate are cured. In one embodiment, the laminate is a sheet that is placed on the green tire. In an alternative embodiment, the laminate is a ribbon that is wound about the green tire, or is disposed only in the grooves of the tire. In either embodiment, the laminate may be pressed onto the green tire with one or more rollers. Such a process may be referred to as “stitching” and may expel air or other gasses that become trapped between the laminate and the green tire.

In another alternative embodiment, the laminate is disposed on a cured tire. Such a laminate may be applied to the tire using a vacuum process. In one embodiment, the laminate is a sheet that is placed on the cured tire. In an alternative embodiment, the laminate is a ribbon that is wound about the cured tire, or is disposed only in the grooves of the tire.

In yet another alternative embodiment, the laminate is applied to a new tread during a tire re-treading process. In such an embodiment, the laminate may be applied to the new tread in the same manners described above. For example, the laminate may be co-extruded with the new tread. Alternatively, the laminate may be place as a sheet on the new tread or wound around the new tread. In such an embodiment, the laminate may be “stitched” to the new tread by using rollers.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire comprising:
a pair of sidewalls;
a circumferential tread constructed of a base rubber, the circumferential tread having a plurality of grooves disposed therein, thereby defining a plurality of tread elements; and
a polymeric laminate disposed on the circumferential tread,
wherein the polymeric laminate covers at least one of the plurality of grooves,
wherein the polymeric laminate covers a top surface of at least one of the plurality of tread elements, and
wherein the polymeric laminate has greater snow traction than the base rubber.

2. The tire of claim 1, wherein the polymeric laminate has a lower modulus of elasticity than the base rubber.

3. The tire of claim 1, wherein the polymeric laminate has a plurality of sipes disposed therein.

4. The tire of claim 3, wherein the plurality of sipes terminate in the polymeric laminate without extending to the base rubber.

5. The tire of claim 1, wherein the polymeric laminate has a nominal thickness of between 1 millimeters and 1.5 millimeters.

6. The tire of claim 1, wherein the polymeric laminate is configured to wear off of the top surface of the at least one of the plurality of tread elements during the life of the tire.

7. The tire of claim 6, wherein the polymeric laminate is configured to continue to cover the at least one of the plurality of grooves after the polymeric laminate has worn off of the top surface of the at least one of the plurality of tread elements.

8. The tire of claim 1, wherein the polymeric laminate covers at least one of the pair of sidewalls.

9. The tire of claim 1, wherein the polymeric laminate has a different color than the base rubber.

10. The tire of claim 1, further comprising an inner laminate layer disposed between the base rubber and the polymeric laminate.

11. The tire of claim 10, wherein the inner laminate layer is constructed of a material that exhibits wet performance superior to the base rubber and superior to the polymeric laminate.

12. A tire comprising:
a circumferential tread constructed of a base material,
wherein the circumferential tread has a plurality of tread elements, each of the plurality of tread elements having a top surface and a plurality of side surfaces, and
wherein the circumferential tread further has a plurality of grooves disposed between the plurality of tread elements; and
a laminate covering at least some of the plurality of tread elements and at least some of the plurality of grooves, wherein the laminate has greater snow traction than the base material.

13. The tire of claim 12, wherein the tire is constructed by coextruding the laminate with the base material.

14. The tire of claim 12, wherein the tire is constructed by placing a calendered sheet of laminate on a green tire.

15. The tire of claim 14, wherein the tire is constructed by stitching the calendered sheet of laminate to the green tire.

16. The tire of claim 12, wherein the laminate has a lower modulus of elasticity than the base material.

17. The tire of claim 12, wherein the laminate has a plurality of sipes disposed therein.

18. The tire of claim 12, further comprising an inner laminate layer disposed between the base material and the laminate.

19. A tire comprising:
a pair of sidewalls;
a circumferential tread constructed of a base rubber,
wherein the circumferential tread has a plurality of tread elements, each of the plurality of tread elements having a top surface and a plurality of side surfaces, and
wherein the circumferential tread further has a plurality of grooves disposed between the plurality of tread elements; and
a laminate disposed on the circumferential tread, such that the laminate covers at least a portion of the plurality of side surfaces of the plurality of tread elements, wherein the base rubber has lower snow traction than the laminate.

20. The tire of claim 19, wherein the base rubber has a higher modulus of elasticity than the laminate.

21. The tire of claim 19, further comprising an inner laminate layer disposed between the base rubber and the laminate.

22. The tire of claim 19, wherein the laminate is constructed of ozone resistant material.

23. A tire comprising:
a pair of sidewalls, including a first sidewall and a second sidewall;
a circumferential tread constructed of a base rubber, the circumferential tread having a plurality of grooves disposed therein, thereby defining a plurality of tread elements;
a pair of shoulders, including a first shoulder extending from the circumferential tread to the first sidewall and a second shoulder extending from the circumferential tread to the second sidewall; and
a laminate disposed on at least one of the pair of shoulders, wherein the polymeric laminate has greater snow traction than the base rubber.

24. The tire of claim 23, wherein the laminate is disposed on the first shoulder and the second shoulder.

25. The tire of claim 23, wherein the laminate covers at least one of the pair of sidewalls.

26. The tire of claim 23, wherein the laminate covers a top surface of at least one of the plurality of tread elements.

27. The tire of claim 23, wherein the polymeric laminate has a lower modulus of elasticity than the base rubber.
